(19) United States
(12) Patent Application Publication
(10) Pub. No.: US 2002/0136668 A1
(43) Pub. Date: Sep. 26, 2002

(54) Apparatus and methods for high resolution separation and analysis of compounds

(76) Inventors: David Wallace, Dallas, TX (US); Ting Chen, Richardson, TX (US); Andrew Arthur Gooley, Turramurra (AU); Femia Hopwood, Winston Hills (AU)

Correspondence Address: MI K. KIM, Fish & Richardson P.C., Suite 500, 4350 La Jolla Village Drive, San Diego, CA, 92122, US

(21) Appl. No.: 10/025,965

(22) Filed: Dec. 18, 2001

Related U.S. Application Data
(63) Continuation-in-part of application No. PCT/AU00/00688, filed on Jun. 19, 2000.

(30) Foreign Application Priority Data
Jun. 18, 1999 (AU) PQ1055

(51) Int. Cl. G01N 1/00

(52) U.S. Cl. 422/100; 422/70; 436/161; 436/173; 436/180

(57) ABSTRACT

A microdispensing apparatus comprising a jetting tube comprising an orifice at one end and an aperture at the other end, a transducer coupled with the jetting tube and adapted to apply a pressure pulse to the jetting tube in response to an electrical signal applied to the transducer such that liquid in the jetting tube is caused to pass therethrough, and means for collecting, capturing or retaining one or more compounds from liquid passing the jetting tube; a system for sampling, collecting and dispensing compounds in small volumes of liquid including the microdispensing apparatus; and methods of sampling, collecting and arraying small quantities of compounds in a liquid sample on a target.

### CROSS REFERENCE TO RELATED APPLICATION

This application is a continuation-in-part and, thus, claims the benefit of priority under 35 U.S.C. §120 of PCT Application No. PCT/AU00/00688, filed Jun. 19, 2000 and published in English on Dec. 28, 2000 as WO/0079238; which claims priority to Australian Application No. PQ1055, filed Jun. 18, 1999. The disclosure of the prior applications is considered part of and is incorporated by reference in their entirety to the present application.

### TECHNICAL FIELD

The invention relates to apparatus and methods for separating and analyzing compounds, particularly biomolecules using a microdispensing apparatus and systems.

### BACKGROUND ART

Sensitivity and specificity of analysis of compounds is improving due to the development of highly sensitive systems for analysis. Unfortunately, the development of systems to handle very small volumes of compounds in extremely low concentrations has not kept up with the analysis technology. There are many situations where only small amounts of sample, containing limited concentrations of compounds, are available for testing or analysis. Present sampling technologies have limited use in many of these situations.

Mass spectrometry (MS) is a preferred method for characterizing proteins, peptides, glycopeptides and peptides with other modifications, lipids, oligosaccharides and oligonucleotides (herein collectively called biomolecules) as their fragments are analyzed on the MS to yield a very accurate mass. This data, along with a biomolecules' fragmentation pattern, is referenced to databases containing sequences of all known biomolecules.

Prior to examination by MS, the biomolecules are typically separated from each other and their buffered environment using a variety of chromatography techniques. Characterization of such purified biomolecules is often conducted by analyzing their fragments. In the case of proteins, this typically involves the use of an enzyme such as trypsin, which specifically cleaves the proteins into fragments. In order to separate biomolecule fragments from a mixture, the fragments may be passed over a stationary phase, such as silica beads derivatized with functional groups.

Separation of fragments is commonly used for the analysis of peptides by liquid chromatography-electrospray ionization-mass spectrometry (LC-ESI-MS). For LC-ESI-MS, the peptide sample is introduced as a liquid droplet where it takes up a charge before entering the mass spectrometer. This approach does not work for matrix assisted laser desorption ionization (MALDI), however, as there is no liquid interface. In contrast, the peptide takes on its charged state via a UV absorbing matrix. In MALDI, a technique called post-source decay (PSD) is typically used to generate fragmentation data. While it is not necessary to separate the peptide prior to implementing the PSD experiment (candidate peptides are chosen by ion-selection), the process is neither automated nor robust. Many candidate peptides are suppressed by neighboring ions and hence are not sufficiently ionized for selection.

Several research groups have implemented an LC interface to the MALDI whereby samples are collected from a liquid chromatography (LC) column and manually deposited onto a MALDI-TOF MS sample plate. The UV absorbing matrix is then applied manually. Recently, a device has been developed that will automatically spot both the fractions from the LC column and the MALDI matrix onto the MALDI-TOF MS sample plate. However, the volumes dispensed are large, in the order of 1 μL, and a large volume of solution that contains no peptides is also deposited.

The present inventors have now developed a microdispensing apparatus with an integrated compound capture capability. The microdispensing apparatus, when used in appropriate systems, can deposit single or multiple spots of separated compounds, preferably in an array, from a sample onto a target. The integrated capture capability allows separation and concentration of compounds such as biomolecule fragments, providing an ideal substrate for subsequent fragmentation experiments using either mass spectrometry or enzymatic approaches. As the fractions can be collected directly onto a target, depending on the system the analysis can be extremely sensitive as in the case of the LC-ESI-MS approach without sacrificing the high-throughput characteristics of MALDI.

### DISCLOSURE OF INVENTION

In a first aspect, the present invention provides a microdispensing apparatus for sampling, collecting and dispensing a compound in small volumes of liquid. The apparatus includes a jetting tube comprising an orifice at one end and an aperture at the other end. A transducer can be coupled with the jetting tube and adapted to apply a pressure pulse to the jetting tube in response to an electrical signal applied to the transducer such that liquid in the jetting tube is caused to move and is characterized by a retaining means for collecting, capturing or at least temporarily retaining one or more compounds from liquid contacting said means in the apparatus. The transducer can be disposed between the retaining means and the orifice of the jetting tube. In an alternative embodiment, the retaining means forms part of and modifies an inner surface of the jetting tube. At least a part of that modified inner surface extends and is located between the aperture of the jetting tube and the transducer. The retaining means can be any type of retainer.

In a preferred embodiment, the microdispensing apparatus is adapted to deliver accurate volumes of liquid in drop form of at least about 5 μM in diameter. Typically, drop sizes of around 50 to 200 μM are used in chemical and biological applications. This diameter of drop is convenient for laser interrogation in MS instruments. In a preferred form, the volume deposited will be such that the size of the laser beam is equivalent to the deposited spot (about 50-100 μM). The small drops are formed when liquid is caused to pass through the orifice.

Small volumes are usually less than about 1 μL, preferably about or less than about 0.1 μL, depending on the situation. The apparatus can dispense larger volumes not in drop form when used in a spray configuration. This type of liquid dispensing may be used to wash or rinse the jetting tube.

The jetting tube is typically made from glass but other substances such as metals and plastics may also be used.

Transducers suitable for the present invention are piezoelectric, magneto-strictive, electro-strictive or electromechanical. Preferably, the transducer is piezoelectric. Suitable piezoelectric materials for the transducer include lead zirconate titanate (pzt material).

The means for collecting, capturing or retaining one or more compounds can be any form of reactive material, usually provided as a stationary phase. Suitable stationary phase materials include, but are not limited to, chromatography materials and substrates, physical packings which contain reactive groups capable of binding and releasing compounds, surface active groups capable of binding and releasing compounds, immobilized ligands, and derivatized surfaces.

Preferably, the stationary phase is a derivatized stationary phase material in the form of a high performance liquid chromatography (HPLC) column packing.

The means for collecting, capturing or retaining one or more compounds can be associated with the jetting tube, placed anywhere within the jetting tube, or form part of an inner surface of the jetting tube.

The microdispensing apparatus may contain a plurality of jetting tubes under the control of the same or separate transducers. The plurality of jetting tubes may have the same or different means for collecting, capturing or retaining one or more compounds.

The apparatus can be reusable, disposable or adapted to receive different jetting tubes.

The advantage of the apparatus according to the first aspect of the present invention is that very small samples with minute amounts of compounds can be sampled accurately. The compounds that are retained by the apparatus can be eluted in concentrated form in small accurate volumes for further analysis. Relatively large volumes of sample (in the μL range)(can be passed through the jetting tube and the compound(s) of interest will be captured by the collecting means. Depending on the collecting means used, the retained compound(s) can be released by change of conditions of the liquid passing the jetting tube. The eluting conditions include, but not limited to, ionic strength, solvent, salts, surfactants, chemical stripping, pressure drop or increase and the like.

The apparatus according to the first aspect of the present invention is suitable for the collection and analysis of any compound that can be captured by some physical means. Examples of compounds include, but are not limited to, chemicals, pesticides, herbicides, drugs, biomolecules including proteins, peptides, glycopeptides and other modified peptides, glycoproteins, nucleic acids, hormones, steroids, enzymes, co-factors, recombinant proteins, antigens, antibodies and their fragments.

Samples that can be analyzed include, but are not limited to, environmental, clinical including urine, plasma, blood products, solubilized tissue samples, solutions of peptide fragments, and solutions of gene fragments.

Samples can be applied from the aperture of the jetting tube, passing the collecting means, and out through the orifice in a controlled manner. Alternatively, the apparatus can be used to sample in a “dip and sip” manner, where the sample is applied through the orifice to the collecting means and eluted back through the orifice.

In a second aspect, the present invention provides a system for sampling, collecting and dispensing a compound in small volumes of liquid. The apparatus can include a microdispensing apparatus according to the first aspect of the present invention. The apparatus can also include a means for applying an electrical signal to the transducer, a means for controlling the strength and frequency of the electrical signal to control the precise movement of liquid within, or to and from the jetting tube of the microdispensing apparatus, a means for applying a sample to the jetting tube such that at least some compounds in the sample are captured or retained by the collecting means of the microdispensing apparatus, and a means for providing liquid to or from the jetting tube such that the tube may be washed and any compounds captured or retained by the collecting means can be eluted or removed.

In a preferred embodiment, the system can further include a means for arraying eluted compounds, preferably on an X-Y target, onto a capture device.

In another preferred embodiment, the system can further include a means for controlling the means for applying the sample to the jetting tube, providing the liquid to and from the jetting tube, and arraying the sample. Preferably that means for control is through a computer.

In a preferred embodiment, the system can further include a means for analyzing the eluted compound.

In a further preferred embodiment of the present invention, the capture device is a device designed to be inserted in to the analyzer. Suitable examples include use of photoelectrical, photochemical, laser, radiochemical, and mass spectral devices. It will be appreciated that the analyzing step can be carried out some time after the arraying of the compound(s).

In one preferred form, the analyzer is a matrix-assisted laser desorption ionization-time of flight mass spectrometer (MALDI-TOF MS).

In a third aspect, the present invention provides a method of sampling, collecting and arraying small quantities of one or more compounds in a liquid sample on a target, the method comprising the steps of providing a microdispensing apparatus according to the first aspect of the present invention; applying a liquid sample containing one or more compounds to the jetting tube of the microdispensing apparatus such that at least some of the compounds in the sample are retained by the collecting means of the microdispensing apparatus; optionally washing the jetting tube to remove any non-bound material present in the jetting tube; eluting the retained compound(s) from collecting means; and arraying the eluted compound(s) in small volumes onto a capture device.

The steps may be repeated or cycled so as to carry out a series of separations of a number of different samples.

In a preferred embodiment, the method can further include a means for analyzing the arrayed and eluted compound.

Examples of suitable capture devices include membranes such as polyvinylidene fluoride, polyurethane, nitrocellulose, nylon, teflon and gortex, standard microtitre plates of 96, 384 and 1536 microvolume wells, micro-total analysis systems (μ-TAS), metal and glass surfaces, glass capillaries and derivatized surfaces of the above, silica-based media and derivatized forms, synthetic resins and derivatized forms, often cross-linked polystyrene (polystyrene, styrene, divinylbenzene); cross-linked polysaccharides and its derivatized forms (cellulose, dextran, agarose), cross-linked acrylamide and its derivatized forms, polymethacrylate and its derivatized forms, polyhydroxymethacrylate and its derivatized forms, polyvinyl alcohol and its derivatized forms, paramagnetic beads and derivatized forms.

In a further preferred embodiment, the capture device is a device designed to be inserted into an analyzer. Suitable examples include use of photoelectrical, photochemical, laser, radiochemical, and mass spectral devices.

In one preferred form, the analyzer is a matrix-assisted laser desorption ionization-time of flight mass spectrometer (MALDI-TOF MS).

The method according to the third aspect of the present invention is suitable for the collection and analysis of any compound that can be captured by some physical means. Examples of compounds include, but are not limited to, chemicals, pesticides, herbicides, drugs, biomolecules including proteins, peptides, glycopeptides and other modified peptides, glycoproteins, nucleic acids, hormones, steroids, enzymes, co-factors, recombinant proteins, antigens, antibodies and their fragments.

Preferably the compound is one or more peptides (or modified peptides) cleaved from a protein.

Samples that can be analyzed include, but are not limited to, environmental, clinical including urine, plasma, blood products, solubilized tissues, solutions of peptide fragments, and solutions of gene fragments.

The sample can be applied from the aperture of the jetting tube passing the collecting means and out through the orifice in a controlled manner. Alternatively, the apparatus can be used to sample in a “dip and sip” manner where the sample is applied through the orifice to the collecting means and eluted back through the orifice.

One typical example of the need for the microdispensing of samples is for definitive analyses of proteins separated by two-dimensional polyacrylamide electrophoresis (2-D PAGE). Important attributes in the analyses of proteins include peptide purity and total peptide coverage (including modified peptides); the more peptides recovered the more confidence is attached to the putative identity of the protein. Analysis of the micro samples may also be used to identify the protein.

Increasingly, there has been a need to generate a “sequence tag”, which is a short stretch of sequence generated by either mass spectrometry-derived fragmentation or enzymatic degradation of a peptide, to facilitate the identity of the protein or to study post-translational modification on the peptide of interest. However, generating fragment data in a MALDI is not trivial. There are two approaches: the first is an experiment called post-source decay, which effectively tunes the mass spectrometer detector to detect metastable fragments induced by the laser desorption. The second is enzymatic (protease) degradation in situ on the target biomolecule, which generates a peptide ladder; the mass difference between fragments results from the enzymatic release of amino acids. Both approaches would be simplified if the peptide fragments were arrayed in a manner that facilitated their separation from contaminating peptides. In addition, the capacity to array peptides would also enhance the protein coverage, as the problem of ion suppression is addressed by the process of separating the peptide mixture into simpler components in a time dependent and, hence, spatial manner.

In a fourth aspect, the present invention provides use of the apparatus according to the first aspect of the present invention or the system according to the second aspect of the present invention in sampling, collecting and dispensing a compound in small volumes of liquid.

Any description of prior art documents herein is not an admission that the documents form part of the common general knowledge of the relevant art in Australia.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In order that the present invention may be more clearly understood, preferred forms will be described with reference to the following examples and accompanying drawings.

### BRIEF DESCRIPTION OF DRAWINGS

FIG. 1 is a schematic representation of one embodiment of a microdispensing device where the collecting material in the form of a solid support is integrated above the transducer near the aperture of the jetting tube.

FIG. 2 is a schematic representation of an embodiment of a microdispensing device where at least part the internal surface of the jetting tube is derivatized with a collecting material.

FIG. 3 shows the effect of voltage verses length of the jetting tube in a microdispensing apparatus according to the present invention.

FIG. 4 is a schematic representation of a process of obtaining a high-density array of compounds by way of microdispensing of at least one sample from an array of samples.

FIG. 5 is a schematic view of a system for microdispensing an array of collected compounds onto a target.

FIG. 6 shows results of an array of peptide fragments, derived from a tryptic digest of a protein, dispensed from a microdispensing device according to the present invention over 5 minutes.

### MODES FOR CARRYING OUT THE INVENTION

### Microdispensing Apparatus

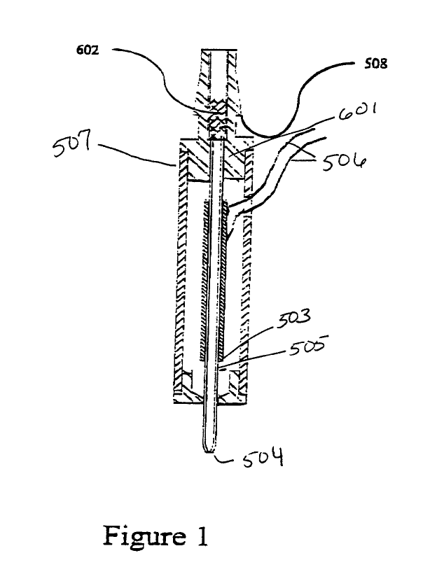

An embodiment of a type of microdispensing device is where collecting means in the form of chromatography packing material is connected to the aperture of the microdispensing device is shown in FIG. 1. A PZT tube (503) is concentrically bonded with a glass capillary jetting tube (505), which comprises an orifice (504) at one end. The leads (506) on the PZT electrodes are for electric connections. This unit is housed within a case (507). A barbed ferrule (508) provides fluid connection, and connects to the LC resin collecting material (601). The length of the collecting material (601) is variable, depending on the requirement of compound separation. The length of the PZT tube (503), and also the length of the glass capillary jetting tube (505), is selected to balance the trade-off between the reduction in dead volume and the gain in piezoelectric driving efficiency (a short tube has smaller dead volume and lower driving efficiency, and visa versa).

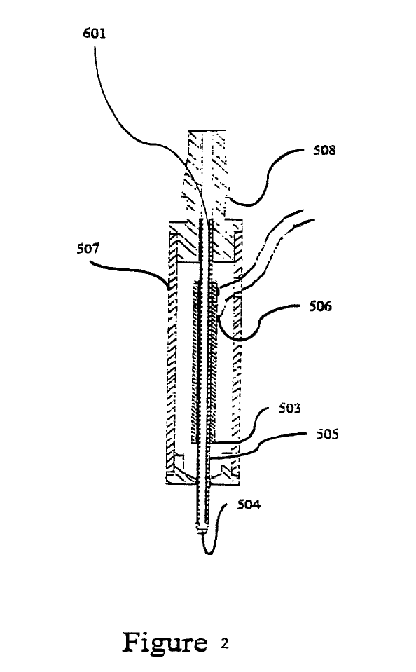

Another embodiment of a microdispensing device where the chromatography packing material is integrated into the capillary of the microdispensing device is shown in FIG. 2. The functionality of the fluid dispensing is the same as in FIG. 1. The design offers high piezoelectric driving efficiency. When the LC resin is packed close to the orifice, the dead volume can be less than 0.5 μL.

The construction of microdispensing devices which could be modified to include a collecting means according to the present invention is described in patents by Zoltan (U.S. Pat. No. 3,902,083) and Hayes (U.S. Pat. No. 4,877,745). The present invention could be adapted to almost any ink-jet print head configuration, such as Kyser (U.S. Pat. No. 3,946,398) or Pies (U.S. Pat. No. 5,235,352).

Operational characteristics of suitable microdispensing devices can be found in: D. B. Wallace, “A Method of Characteristics Model of a Drop-On-Demand Ink-Jet Device Using an Integral Drop Formation Method,” ASME publication 89-WA/FE-4, December 1989; D. B. Wallace, V. Shah, D. J. Hayes, and M. E. Grove, Proceedings, “Photo-Realistic Ink Jet Printing Through Dynamic Spot Size Control,” IS&T's 11th Int. Congress in Non-Impact Printing Technologies, October 1995; also Journal of Imaging Science & Technology, Vol. 40, no. 5, pp. 390-395, 1996; D. B. Bogy and F. E. Talke, “Experimental and Theoretical Study of Wave Propagation Phenomena in Drop-On-Demand Ink Jet Devices,” IBM Journ. Res. Develop., Vol. 29, pp. 314-321, 1984; and J. F. Dijksman, “Hydrodynamics of Small Tubular Pumps,” Journ. Fluid Mech., Vol. 139, pp. 173-191, 1984.

A Piezoelectric LC device is preferred for the collection and dispensing of peptides and other biomolecules as it provides two basic functions: dispensing micro drops and fractionating compounds. With a Piezoelectric LC device, a compound array can be printed for most analyses, particularly MALDI analysis. The dispensing part of the device is a concentrically bonded unit of a PZT (lead zirconate titanate) tube and a glass capillary. An orifice is formed at one end of the glass capillary. The piezoelectric displacement of the PZT generates a pressure wave in the fluid inside the glass capillary and induces drop ejection from the orifice. The fractionating part of the device is a column of LC resin, which consisted of silica beads fixed within a polymeric scaffold. In one embodiment, the LC resin material is a proprietary product of Millipore Corporation. A system according to the present invention is suitable with an effective integration of the drop dispensing mechanism with the LC capability to form a monolithic device for high resolution MALDI analysis.

A number of different designs and prototypes of the microdispensing apparatus have been produced. (See FIGS. 1 and 2.)

A PZT tube is concentrically bonded with a glass capillary, which comprises an orifice at one end. The leads soldered on the PZT electrodes are for electric connections. This unit is housed within a case. A barbed ferrule provides fluid connection and also houses the LC resin material, which formed the capture means. In one example (FIG. 1), the LC resin material (602) is packed above the interrupted glass capillary via a direct bonding to the ferrule or via intermediate tubing. The length of the material is variable, depending on the requirement of compound separation. The length of the PZT tube, and also the length of the glass capillary, is selected to balance the trade-off between the reduction in dead volume and the gain in piezoelectric driving efficiency (a short tube has smaller dead volume and lower driving efficiency, and vice verse). This design has the advantage of ease of fabrication.

Table 1. Parts and materials of the microdispensing apparatus as shown in FIGS. 1 and 2.

| Part Description | Materials |
|---|---|
| Jetting tube | borosilicate glass, other glass |
| Orifice | borosilicate glass, other glass |
| PZT tube | PZT 5H, PZT 5A, other piezoelectric materials |
| Leads | Teflon coated copper wire, other conducting wires |
| Housing | Metal, polymer |
| Ferrule | metal, polymer |
| LC resin column | C₁₈, C₄ (or other functional materials) HPLC |
| | column packing |
| Intermediate tubing | PEEK, other polymers |

The principles of the examples of the apparatus described above are applicable to other configurations of dispensing devices, for example, to array print head with multiple jetting tubes.

Table 2 shows typical dimensions and examples of ranges for the microdispensing device.

TABLE 2
Configuration of microdispensing apparatus examples.

| Part | Dimension | |
|---|---|---|
| Glass Capillary | I.D. (mm) | 0.46 |
| | O.D. (mm) | 0.70 |
| | Length (mm) | 16.1-19.7 |
| PZT tube | I.D. (mm) | 0.76 |
| | O.D. (mm) | 1.27 |
| | Length | 6.4-15.2 |
| | Active Length (mm) | 4.8-13.7 |
| LC resin material | Diameter (mm) | 0.91 |
| | Length (mm) | 1.0-3.0 |
| | Volume (μL) | 0.7-2.0 |
| Orifice | Diameter (μm) | 10-100 |
| Device | Total length (mm) | 21.7-25.2 |

The dimensions listed in Table 2 are for example only and can be changed, as long as the device can be effectively driven and the compounds can be precisely dispensed.

The Piezoelectric LC device can be driven by simple trapezoidal pulses. Distilled water was used as dispensing fluid for device evaluation. The rise time and the fall time of the pulse were both set as 3 μs. In a standard routine, the pulse width was adjusted to obtain a maximum drop velocity, and then the pulse height was adjusted to obtain desired drop velocity. Typical data for water dispensing of 2 m/s at 250 Hz were: pulse height 20 V and pulse width 25 μs for the first example of FIG. 1.

In the design of FIG. 1, the LC column is located beyond the piezoelectric and fluid-mechanical function area of the device. Therefore, the device's drop-on-demand performance is not affected by this additional upstream collecting material. For water dispensing at 250 Hz with drop velocity of 2 m/s, the device is typically driven by simple trapezoidal pulses of 20˜60 μs.

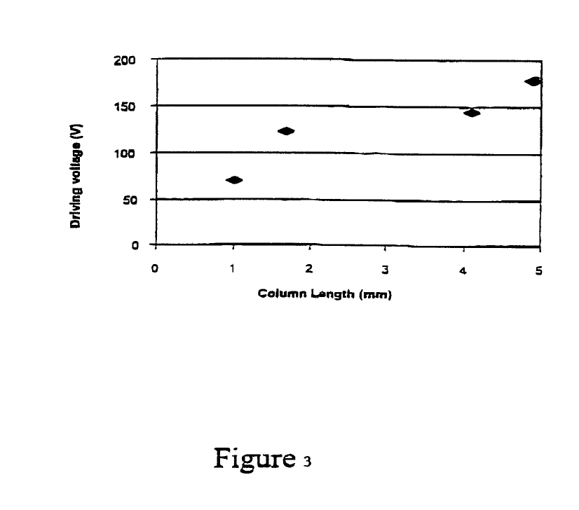

For all insertions, water dispensing at 250 Hz is adjusted to have the same drop velocity of 2 m/s. The driving voltage for each case versus the corresponding column length is shown in FIG. 3. The zero length is referred to an empty PEEK tubing (without filling). When the column length is about 5 mm, the voltage is over 170 V for uni-polar driving pulses. This driving voltage dropped to 70 V when the column length was decreased to 1 mm. This measurement was repeated on other devices. The concrete voltage value varied, but the tendency remained unchanged. The internal cross section area of the PEEK tubing was 0.22 mm². Thus, the 1 mm long column used had the volume of 0.2 μL, which was the minimum resin volume used. Therefore, it is possible to find a column length which satisfies both protein separation accuracy and device driving convenience.

Piezoelectric devices and LC columns were first fabricated separately and then assembled together. In further developments, these two parts can be combined permanently to form a monolithic device or can stay independently. For example, in the design of FIG. 1, a plastic barbed ferrule was first filled with LC resin and then assembled with other parts. This plastic barbed ferrule can be designed to be a disposable part, which can be removed and replaced.

### Collecting Means for the Microdispensing Apparatus

Any material that is capable of binding or retaining compounds would be suitable for the collecting means for the present invention. Examples include silica-based media and its derivatized forms, synthetic resins and derivatized forms, often cross-linked polystyrene (polystyrene, styrene, divinylbenzene), cross-linked polysaccharides and its derivatized forms (cellulose, dextran, agarose), cross-linked acrylamide and its derivatized forms, polymethacrylate and its derivatized forms, polyhydroxymethacrylate and its derivatized forms, and polyvinyl alcohol and its derivatized forms.

The glass of the jetting tube is particularly suited to add materials or reactive groups such that the collecting means is formed within the tube. Suitable examples of such chemistries that are suitable involve the chemical modification of the hydroxyl groups of silica gel by reaction with various organochlorosilanes. Some examples are provided below.

(I) Anal Biochem 1997 5;247(1):96-101 Covalent attachment of hybridizable oligonucleotides to glass supports, Joos B., Kuster H., Cone R.

Glass slides can be derivative with aminophenyl or aminopropyl silanes and 5′-succinylated and target oligonucleotides attached by carbodiimide-mediated coupling (this type of chemistry allows approximately 40 to 50% of the applied target oligonucleotides to covalently bind to the derivative glass). Carbodiimide-mediated coupling can be used for the coupling of carboxylic acids to amines. Hence, derivatization of the glass surface with either an amine or carboxyl functional group allows carbodiimide-mediated coupling of proteins or peptides.

(III) Biosens Bioelectron 1999 14(8-9):703-13 Development of sensors for direct detection of organophosphates. Part I: Immobilization, characterization and stabilization of acetylcholinesterase and organophosphate hydrolase on silica supports. Singh A. K., Flounders A. W., Volponi J. V., Ashley C. S., Wally K., Schoeniger J. S. Sandia National Laboratories, Chemical and Radiation Detection Laboratory, Livermore, Calif. 94551-0969, U.S.A.

Two different covalent chemistries can be used to immobilize AChE and OPH to porous and non-porous silica glass. The first chemistry is amine-silanization of silica followed by enzyme attachment using the homobifunctional linker glutaraldehyde. The second chemistry is sulfhydryl-silanization followed by enzyme attachment using the heterobifunctional linker N-gamma-maleimidobutyryloxy succinimide ester (GMBS). Surfaces can be characterized in terms of total enzyme immobilized, total and specific enzyme activity, and long-term stability of enzyme activity. Amine derivatization followed by glutaraldehyde linking can yield supports with greater amounts of immobilized enzyme and activity. Use of porous supports not only yielded greater amounts of immobilized enzyme and activity, but also significantly improved long term stability of enzyme activity. Enzyme can also immobilized to sol-gel coated glass. The mass of immobilized enzyme can be increased linearly with thickness of coating.

Surface-confined living radical polymerization for growing smooth nanometer polymer films.

### Uses of the Microdispensing Apparatus

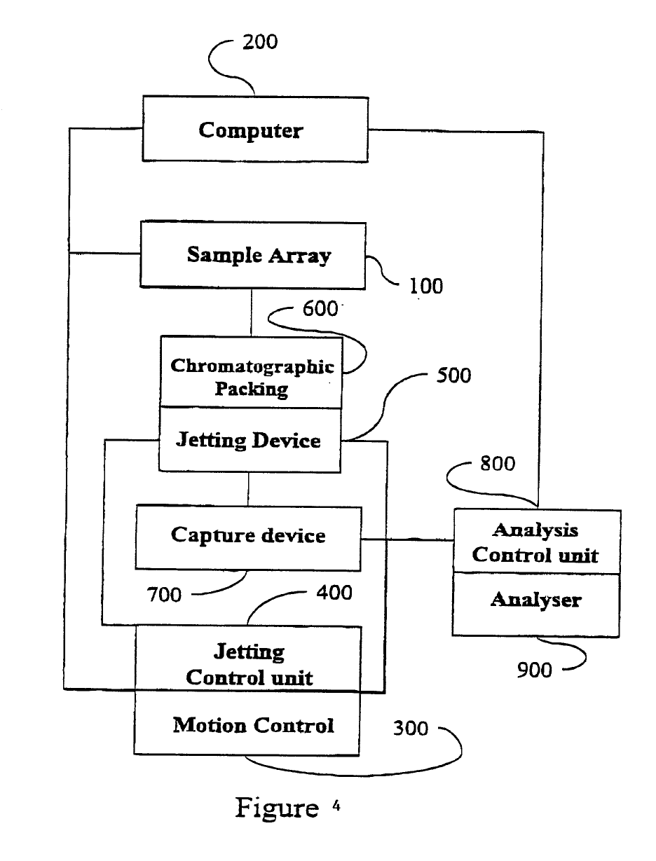

Referring to the drawings, FIG. 4 shows a schematic representation of one embodiment of the method according to the present invention. The system comprises an array of biomolecules (100), a computer (200), a motion control stage (300), a plurality of microdispensing or jetting control units (400), a plurality of chemical microdispensing or jetting units (500) with attached or integrated chromatography packing (600), a capture device for collecting the dispensed biomolecules (700), an analyzer control unit (800) and analyzer (900).

The array of biomolecules (100) is positioned on or near the dispensing unit (500), upstream from the chromatography packing (600). The sample (100) is delivered to the chromatography packing (600) using any mobile phase known to the art of liquid chromatography, either by traditional microfluidic positive displacement, such as a microstepper controlled syringe pump, or by a means whereby the process of microdispensing fluid through a piezoelectric dispensing device (500) actively pulls the sample across the chromatography packing (600). Changing the chemical properties of the mobile phase allows the biomolecules to elute from the chromatography packing (600), into the microdispensing device (500). The microdispensing device (500) is under the control of a microdispensing control unit (400), which is controlled by the computer (200) and dispenses components of the sample onto the capture device (700). The capture device (700), or the microdispensing device (500), is under the control of a motion control stage (300), which moves to specific predetermined coordinates allowing deposition of samples from the microdispensing device (500), onto the capture device (700). When all samples of biomolecules have been dispensed onto specific coordinates of the capture device (700), these coordinates are used to program an analysis control unit (800), which positions each sample into the path of an analyzer (900).

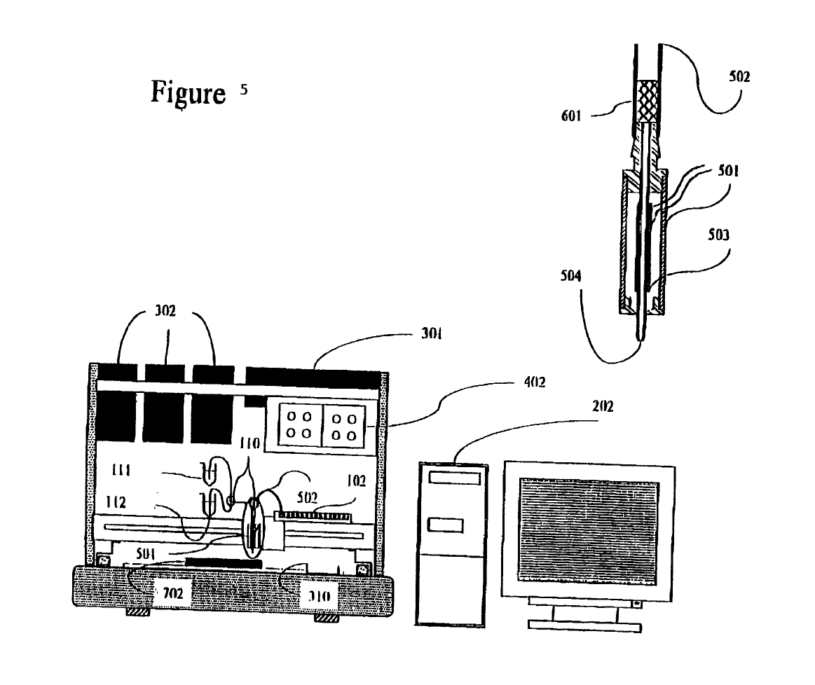

In one embodiment of the method and system according to the present invention, the motion control stage, a MALDI-TOF MS capture device, a microdispensing control unit, a dispensing device and sample array, all under the control of a computer, is shown in FIG. 5. An array of samples (102) is fixed onto or near the dispensing device (501) which is connected to the array of samples via a sample inlet tube (502). Electronic activation of the microdispensing device (501) is by a microdispensing control unit (402), which applies a pulse in the shape of a bipolar trapezoid. The pulse is sent to a piezoelectric (PZT) element (503) held within the microdispensing device (501). The microdispensing device (501) has attached or integrated in it a micro-column of stationary-phase (601). The vibration of the PZT element (503) creates an acoustic wave, which draws the sample of biomolecule fragments (102) into the column (601). Micro-switching valves (110) allow switching between washing solution (111), which removes salts from the biomolecule fragment solution (102) to waste (310), and elution solution (112). As the elution solution reaches the column (601) the microdispensor (501) is lowered under the control of a z-axis driver (302) so that the microdispensor orifice (504) is within several mm of the MALDI target (702). Fractions are dispensed onto a pre-determined array of X-Y coordinates of the MALDI target in either a time-dependent of volume-dependent manner (volumes of a jetted droplet are in the order of several picoliters). Hence, each X-Y coordinate represents a fraction of the biomolecule digest (102). Following the dispensing of the pre-determined array of sample droplets onto the MALDI target, the microdispensing device inlet tube (502) is moved into a new sample well (102) under the control of a 3-axis controller (301) and x, y and z-axis drivers (302). The movement of the microdispensing device inlet tube (502) into the next sample in the microtitre plate sample array (102) corresponds to an identical movement of the microdispensor orifice (504) directly above a new MALDI target position (702). The speed of dispensing is controlled from the electronics (402) varying the voltage, frequency and dwell of the bipolar trapezoid pulse. A computer (202) controls the motion control stage controller (301), the microdispensing device electronics (402) and the micro-switching valves (110).

The elution solution (112) can be a buffer which may contain a matrix which absorbs heat energy from irradiation with UV light (typically a nitrogen laser). If the elution solution (112) does not contain the heat energy-absorbing matrix, a second microdispensing device may be used to dispense a matrix solution either before or after the sample fragments are dispensed onto the MALDI target (702). The target can be metal or membrane attached to the metal target, or even a disposable membrane target.

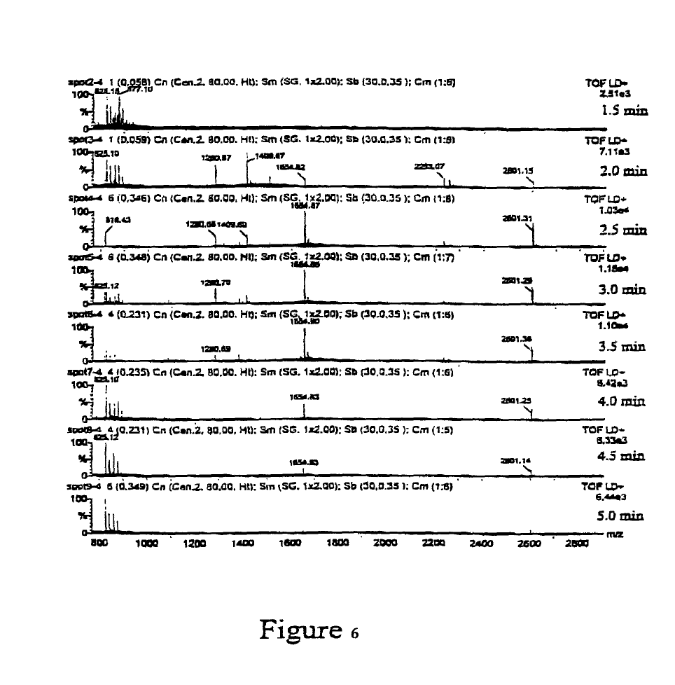

An example of the analysis of a dispensed array is shown in FIG. 6. A tryptic digest of the Escherichia coli outer membrane protein, OMPA, purified by 2-D PAGE from an E. coli whole cell lysate was loaded onto a microdispensing device of the design shown in FIG. 5. Two microliters of the OMPA digest was diluted into ten microliters of deionized water and was drawn into the jetting tube having as collecting material C18 packing. The electronic conditions for dispensing were 0.1 μs rise and fall, a voltage of 100 V, a frequency of 100 Hz, a dwell of 100 μs, and a drops/trigger setting of 255. Once the sample was loaded onto the collecting material, the jetting tube was washed with 3×ten microliters of deionized water using the electronic settings described above. The peptides were eluted from the material in a time-dependent manner using the buffer 50% (v/v) acetonitrile containing 0.5% (v/v) trifluoroacetic acid. The electronic settings for dispensing the elution buffer were identical to those described above. Each fraction was collected onto a target containing several hundred nanoliters of the organic acid, alpha-cyano-4-hyroxycinnamic acid, at a concentration of 10 mg/mL⁻¹ in 50% (v/v) acetonitrile containing 0.5% (v/v) trifluoroacetic acid.

To assist in understanding the separation of the peptide digest several peaks have been labeled with their observed masses (FIG. 6). It is clearly observed that some masses preferentially elute in different fractions. For example, the peptide ion 1654.8 elutes predominantly in fractions 3-5, while the peptide ion 1409.6 elutes almost exclusively in fraction 2.

The results show that it is possible to sample, collect and analyze small amounts of peptide fractions using the system and apparatus according to the present invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A microdispensing apparatus for sampling, collecting and dispensing a compound in small volumes of liquid, the apparatus comprising:
(a) a jetting tube comprising an orifice for dispensing liquid therefrom at one end and an aperture at the other end;
(b) a transducer coupled with the jetting tube and adapted to apply a pressure pulse to the jetting tube in response to an electrical signal applied to the transducer such that liquid in the jetting tube is caused to move; and characterized by
(c) retaining means for collecting, capturing or at least temporarily retaining one or more compounds from liquid contacting said means in the apparatus; and
wherein the transducer is disposed between the retaining means and the orifice of the jetting tube.

2. A microdispensing apparatus for sampling, collecting and dispensing a compound in small volumes of liquid, the apparatus comprising:
(a) a jetting tube comprising an orifice for dispensing liquid therefrom at one end and an aperture at the other end;
(b) a transducer coupled with the jetting tube and adapted to apply a pressure pulse to the jetting tube in response to an electrical signal applied to the transducer such that liquid in the jetting tube is caused to move; and characterized by
(c) retaining means for collecting, capturing or at least temporarily retaining one or more compounds from liquid contacting said means in the apparatus;
wherein said retaining means forms part of and modifies an inner surface of the jetting tube and wherein at least a part of that modified inner surface extends and is located between the aperture of the jetting tube and the transducer.

3. The apparatus of claim 1 wherein the retaining means is positioned in a tube which is adjacent to and co-axial with the jetting tube.

4. The apparatus according to claim 1 wherein the jetting tube comprises a glass capillary.

5. The apparatus according to claim 1 wherein the transducer is selected from the group consisting of piezoelectric, magneto-strictive, electro-strictive, and electro-mechanical.

6. The apparatus according to claim 1 wherein the retaining means is formed of reactive material capable of retaining a compound or mixture of compounds.

7. The apparatus according to claim 6 wherein the retaining means is a stationary phase.

8. The apparatus according to claim 7 wherein the stationary phase is selected from the group consisting of chromatography materials and substrates, physical packings which contain reactive groups capable of binding and releasing compounds, surface active groups capable of binding and releasing compounds, immobilized ligands, and derivatized surfaces.

9. The apparatus according to claim 1 wherein the retaining means is a derivatized stationary phase material in the form of a high performance liquid chromatography (HPLC) column packing.

10. The apparatus according to claim 1 comprising a plurality of jetting tubes under the control of the same or separate transducers.

11. The apparatus according to claim 10 wherein the plurality of jetting tubes have the same or different means for collecting, capturing or retaining one or more compounds.

12. The apparatus according to claim 1 arranged for collection and dispensing of a compound selected from the group consisting of chemicals, pesticides, herbicides, drugs, biomolecules including proteins, peptides, glycopeptides and other modified peptides, glycoproteins, nucleic acids, hormones, steroids, enzymes, co-factors, recombinant proteins, antigens, antibodies and their fragments.

13. A system for sampling, collecting and dispensing a compound in small volumes of liquid, the apparatus comprising:
(a) a microdispensing apparatus comprising a jetting tube consisting of an orifice for dispensing liquid therefrom at one end and an aperture at the other end; a transducer coupled with the jetting tube and adapted to apply a pressure pulse to the jetting tube in response to an electrical signal applied to the transducer such that liquid in the jetting tube is caused to move; and retaining means for collecting, capturing or at least temporarily retaining one or more compounds from liquid contacting said means in the apparatus;
wherein the transducer is disposed between the retaining means and the orifice of the jetting tube;
(b) means for applying an electrical signal to the transducer;
(c) means for controlling the strength and frequency of the electrical signal to control the precise movement of liquid to and from the jetting tube;
(d) means for applying a sample to the jetting tube such that at least some compounds in the sample are captured or retained by the collecting means of the microdispensing apparatus; and
(e) means for providing liquid to or from the jetting tube such that the tube may be washed and any compounds captured or retained by the collecting means be eluted or removed.

14. The system according to claim 13 further comprising:
(f) means for arraying eluted compounds, preferably on X-Y target, onto a capture device.

15. The system according to claim 14 wherein the capture device is selected from the group consisting of membranes, microtitre plates, micro-total analysis systems, metal and glass surfaces, glass capillaries and derivatized surfaces, silica-based media and derivatized forms, synthetic resins and derivatized forms, cross-linked polystyrene styrene, divinylbenzene; cross-linked polysaccharides and derivatized forms, cross-linked acrylamide and derivatized forms, polymethacrylate and derivatized forms, polyhydroxymethacrylate and derivatized forms, polyvinyl alcohol and derivatized forms, and paramagnetic beads and derivatized forms.

16. The system according to claim 17 wherein the membranes are formed of polyvinylidene fluoride, polyurethane, nitrocellulose, nylon, teflon, gortex, or combinations thereof.

17. The system according to claim 13 further comprising:
(g) means for controlling means (d), (e) and (f).

18. The system according to claim 17 wherein means (g) is a computer.

19. The system according to claim 13 further comprising:
(h) means for analyzing the eluted compound.

20. The system according to claim 19 wherein the capture device is a device designed to be inserted into an analyzer (h).

21. The system according to claim 20 wherein the analyzer is selected from the group consisting of photoelectrical, photochemical, laser, radiochemical, and mass spectral devices.

22. The system according to claim 21 wherein the analyzer is a matrix-assisted laser desorption ionization-time of flight mass spectrometer (MALDI-TOF MS).

23. A method of sampling, collecting and arraying small quantities of a compound in a liquid sample on a target, the method comprising the steps of:
(a) providing a microdispensing apparatus comprising a jetting tube comprising an orifice for dispensing liquid therefrom at one end and an aperture at the other end; a transducer coupled with the jetting tube and adapted to apply a pressure pulse to the jetting tube in response to an electrical signal applied to the transducer such that liquid in the jetting tube is caused to move; and retaining means for collecting, capturing or retaining one or more compounds from liquid contacting said means and wherein the transducer is disposed in the microdispensing apparatus between the means for collecting, capturing or at least temporarily retaining one or more compounds from liquid in the jetting tube and the orifice of the jetting tube;
(b) applying a liquid sample containing a compound to the jetting tube of the microdispensing apparatus such that at least some of the compound in the sample is retained by the collecting means;
(c) optionally washing the jetting tube to remove any non-bound material present in the jetting tube;
(d) eluting the retained compound from collecting means; and
(e) arraying the eluted compound in small volumes onto a capture device.

24. The method according to claim 23 wherein steps (b) to (e) are repeated or cycled so as to carry out a series of separations of a number of different samples.

25. The method according to claim 23 further comprising:
(f) analyzing the arrayed and eluted compound.

26. The method according to claim 23 wherein the capture device is adapted to be inserted into an analyzer.

27. The method according to claim 26 wherein the analyzer is selected from the group consisting of photoelectrical, photochemical, laser, radiochemical, and mass spectral analyzers.

28. The method according to claim 26 wherein the analyzer is a matrix-assisted laser desorption ionization-time of flight mass spectrometer (MALDI-TOF MS).

29. The method according to claim 23 wherein the sample is applied through the orifice of the jetting tube to the collecting means and the compound eluted through the orifice.

30. The method according to claim 23 wherein the compound is selected from the group consisting of chemicals, pesticides, herbicides, drugs, biomolecules including proteins, peptides, glycopeptides and other modified peptides, glycoproteins, nucleic acids, hormones, steroids, enzymes, co-factors, recombinant proteins, antigens, antibodies and their fragments.

31. The method according to claim 30 wherein the compound is one or more peptides or modified peptides cleaved from a protein.

32. The method according to claim 23 wherein the liquid sample is selected from the group consisting of environmental, clinical including urine, plasma, blood products, solubilized tissues, solutions of peptide fragments of proteins, and solutions of gene fragments.

33. A system for sampling, collecting and dispensing a compound in small volumes of liquid, the apparatus comprising:
(a) a jetting tube comprising an orifice for dispensing liquid therefrom at one end and an aperture at the other end;
(b) a transducer coupled with the jetting tube and adapted to apply a pressure pulse to the jetting tube in response to an electrical signal applied to the transducer such that liquid in the jetting tube is caused to move; and characterized by
(c) retaining means for collecting, capturing or at least temporarily retaining one or more compounds from liquid contacting said means in the apparatus; and
wherein the transducer is disposed between the retaining means and the orifice of the jetting tube.

34. The apparatus of claim 33 wherein the retaining means is positioned in a tube which is adjacent to and co-axial with the jetting tube.

35. The apparatus according to claim 34 wherein the jetting tube comprises a glass capillary.

36. The apparatus according to claim 33 wherein the transducer is selected from the group consisting of piezoelectric, magneto-strictive, electro-strictive, and electro-mechanical.

37. A microdispensing apparatus for sampling, collecting and dispensing a compound in small volumes of liquid, the apparatus comprising:
(a) a jetting tube comprising an orifice for dispensing liquid therefrom at one end and an aperture at the other end;
(b) a transducer coupled with the jetting tube and adapted to apply a pressure pulse to the jetting tube in response to an electrical signal applied to the transducer such that liquid in the jetting tube is caused to move; and characterized by
(c) a retainer for collecting, capturing or at least temporarily retaining one or more compounds; and
wherein the transducer is disposed between the retainer and the orifice of the jetting tube.

38. The apparatus of claim 37 wherein the retainer forms part of and modifies an inner surface of the jetting tube and wherein at least a part of that modified inner surface extends and is located between the aperture of the jetting tube and the transducer.
